(19) United States
(12) Patent Application Publication
(10) Pub. No.: US 2021/0209282 A1
(43) Pub. Date: Jul. 8, 2021

(54) METHOD FOR COMPENSATING VOLTAGE DROP WITH ADDITIONAL POWER MESH AND CIRCUIT SYSTEM THEREOF

(71) Applicant: REALTEK SEMICONDUCTOR CORP., Hsinchu (TW)

(72) Inventors: CHIEN-CHENG LIU, HSINCHU (TW); YUN-CHIH CHANG, HSINCHU (TW)

(21) Appl. No.: 17/037,870

(22) Filed: Sep. 30, 2020

(30) Foreign Application Priority Data
Jan. 6, 2020 (TW) 109100351

(51) Int. Cl. G06F 30/392; H01L 23/50

(52) U.S. Cl. CPC G06F 30/392; H01L 23/50

(57) ABSTRACT

A method for compensating voltage drop with additional power mesh and a circuit system thereof are provided. In the method, circuit layout of the system is segmented into one or more regions. A layout overflow analysis is performed on each of the regions. A routing overflow rate for each region is calculated according to a ratio of an area occupied by signal tracks and power tracks of a power mesh to another area provided for whole route tracks in the same region. After considering a ranking of the routing overflow rates of the regions, the widths of metal wires, a predetermined ratio of IR drop compensation for the circuit system, and a degree of electron migration to be improved, the additional power tracks of the power mesh deployed to the circuit system are decided. The additional power tracks of the power mesh can effectively improve the IR drop.

### CROSS-REFERENCE TO RELATED PATENT APPLICATION

This application claims the benefit of priority to Taiwan Patent Application No. 109100351, filed on Jan. 6, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure is related to a technology for solving voltage drop in a circuitry, and more particularly to a method for compensating the voltage drop by deploying additional tracks of power mesh of the circuitry and a circuit system thereof

### BACKGROUND OF THE DISCLOSURE

With the rapid development of integrated circuit (IC) manufacturing technology, an IC chip can contain high-density circuit cells, in which the wires between the circuit cells are getting more and narrower in width. Therefore, the operating voltages supplied to the circuit cells can be much smaller. However, as the widths of the wires for transmitting power that is supplied to the power mesh on the chip becomes narrower, unexpected voltage drops may occur due to a rise of equivalent resistance of the narrow wires. The voltage drop may result in failure of the chip in a circuit system.

Furthermore, the circuit cells can be manufactured in the layers of the multi-layer IC chip for containing more circuit elements. However, the multi-layer structure of the chip can easily cause problems of the power mesh in supplying power to the circuit cells and the issue of voltage drops.

Referring to FIG. 1, which is a schematic diagram showing a power mesh in an integrated circuit. In the multi-layer integrated circuit, multiple layers of power meshes are deployed in specific layers of the chip. The diagram schematically shows a first set of power tracks 101 and a second set of power tracks 102 that are interlaced and deployed in different layers of the chip. These crisscross power tracks for the power mesh is used to supply power to the circuit elements 105 for various functions designed in the different layers. In addition to the power tracks used for supplying power to the circuit elements 105, a plurality of signal tracks 107 used for transmitting signals are also deployed among the power tracks (101 and 102).

For solving the problems of the above-mentioned voltage drops, a general approach is to modify the design of a power supply, such as a position of the power supply, to compensate the dropped voltage by increasing decoupling capacitors or to compensate the voltage due to the voltage drop.

### SUMMARY OF THE DISCLOSURE

In response to the above-referenced technical inadequacies, the present disclosure provides a method for compensating voltage drop with additional power mesh, and a circuit system thereof. The circuit system is such as an integrated circuit that includes a multi-layer semiconductor structure. Multiple circuit elements and signal tracks there-between are formed on one or more layers of the structure. A power mesh is deployed over the one or more layers of the structure, and the power mesh includes a plurality of longitudinal and latitudinal power tracks.

In the method, the voltage drop formed in the circuits of the circuit system can be compensated by deploying additional power tracks of the power mesh. In the compensation method, the circuit layout of the circuit system is segmented into one or more regions. A layout overflow analysis is performed on each of the regions so as to obtain a routing overflow rate of each region. The additional power tracks of the power mesh to be deployed in the regions are according to a ranking of the routing overflow rates with respect to one or more regions so as to compensate voltage drop of the circuit system.

In one of the aspects, one of the layers of the circuit system is segmented into one or more regions, and the additional power tracks of the power mesh can be deployed on unused metal wires of the layer.

In one aspect of the disclosure, the layout overflow analysis can be performed based on the data such as a plurality of layout tracks being segmented in each region of the circuit system, wires used as signal tracks between the circuit elements of the circuit system, and power tracks of the power mesh. The routing overflow rate can be obtained by dividing an area being occupied by the signal tracks and the power tracks of the power mesh by an area occupied by all of the layout tracks of the same region.

Further, in consideration of the positions and quantities to deploy the additional power tracks, the factors affecting the routing overflow rate includes the width of each metal wire in the layout of the circuit system, an area occupied by the width of the metal wires of the circuit layout of the circuit system, a compensation ratio set by the system for compensating the voltage drop, and/or a degree of electron migration to be improved in the circuit system.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram showing an example of a power mesh in a conventional integrated circuit;

FIG. 2 is a schematic diagram showing a multi-layer 3D structure of SoC in one embodiment of the disclosure;

FIG. 3 is a curve diagram showing a relationship between an operating voltage drop of a circuit element of a chip and time in one embodiment of the disclosure;

FIG. 4 is a schematic diagram depicting a simulation of voltage drops in each region of the circuit layer analyzed by a simulation program in one embodiment of the disclosure;

FIG. 5 shows a flow chart that describes a layout overflow analysis in the method for compensating voltage drop with an additional power mesh according to one embodiment of the disclosure;

FIG. 6 is a curve diagram showing a relationship between the layout tracks and electron migration effect;

FIG. 7 shows a flow chart that describes the method for compensating voltage drop with an additional power mesh according to one embodiment of the disclosure;

FIG. 8 is a schematic diagram showing a portion of the power tracks of the additional power mesh deployed in the circuit layout in one embodiment of the disclosure;

FIG. 9 is a schematic diagram showing a circuit system that performs the method for compensating voltage drop with an additional power mesh according to one embodiment of the disclosure; and

FIG. 10 is a schematic diagram depicting an additional power mesh that performs the method for compensating the voltage drop in one embodiment of the disclosure.

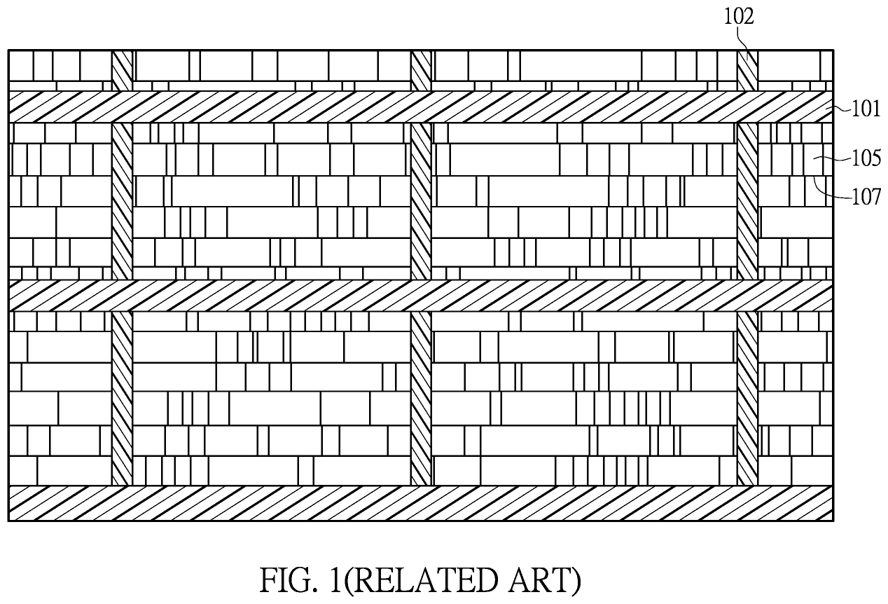

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The modern manufacturing process of semiconductor uses a layer-by-layer stacking method to form a circuit layout. Every layer of the semiconductor structure is configured to form circuit elements of various functions by logical circuits through an individual masking process. A power mesh is designed on the circuit layout. Throughout the circuit design, the power mesh is formed by interconnected power supply and circuit elements designed on a specific layout of several layers. The various circuit elements are designed on the same or different layers of the structure. The system supplies electric power to the circuit elements through the power mesh through vias and wires. Pluralities of signal tracks are connected when linked to an external system or among the circuit elements. In the design of the circuit layout, various metal wires are then deployed on the system.

In a SoC (System-on-Chip), the logic circuits may result in different degrees of voltage drop (IR_Drop). The voltage drop is defined as a phenomenon of voltage loss that occurs in an integrated circuit (IC). The voltage drop occurs because the widths of the metal wires of the power mesh in the semiconductor chip are getting narrower in an advanced semiconductor manufacturing process, and the narrow metal wires cause the resistance over the wires to rise. The voltage drop occurs over a part or the entire circuit system.

Since the manufacturing process of semiconductor continues to develop and advances to the nanometer level process, the voltage drop will cause a greater impact on the logic circuit of the integrated circuit. Therefore, the tolerance of the voltage drop to the circuit system can get smaller in the advanced manufacturing process. Thus, the approach described in the present disclosure can effectively reduce the impact on the integrated circuits due to the voltage drop by optimizing the power mesh of the circuit system.

The disclosure is related to a method for compensating voltage drop with additional power mesh and a circuit system thereof The circuit system is primarily an integrated circuit that is manufactured by a semiconductor manufacturing process. A circuit layout is deployed on the integrated circuit.

In one of the aspects of the disclosure, the compensation method is used to compensate for the voltage drop through the additional power mesh because the advanced manufacturing process will decrease the operating voltages of the circuit system. In the method, a layout overflow analysis is performed to obtain a routing overflow rate with respect to each of the regions of the circuit layout. From the layout overflow analysis, it is acknowledged that more power mesh can be added in the region(s) with a smaller routing overflow rate (e.g., smaller density) proportionally. In an aspect of the disclosure, the available layout tracks in the layout circuit can be provided for deploying additional power tracks of the power mesh. It other words, the layout tracks are used as the additional power mesh for compensating the voltage drop.

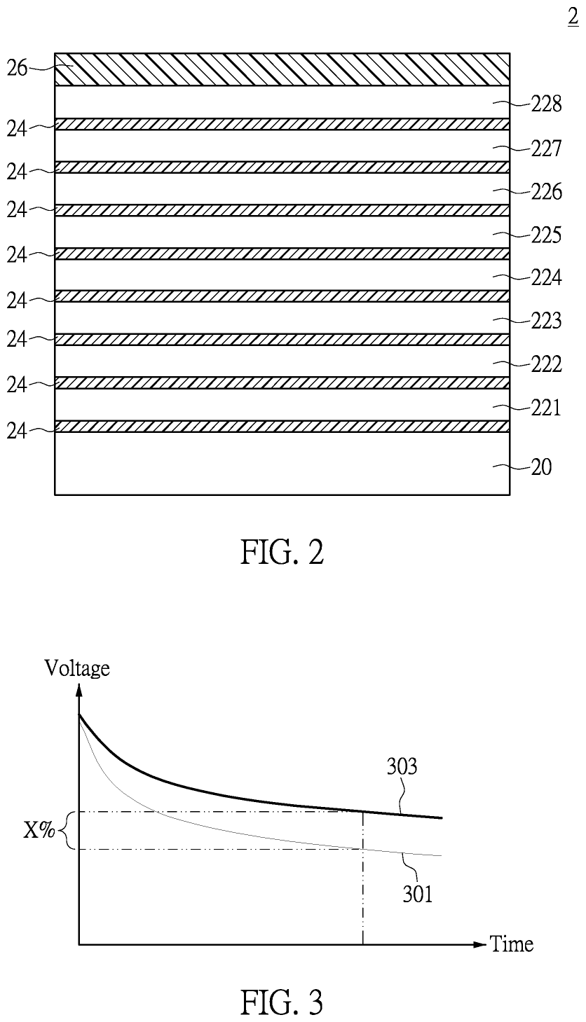

Reference is made to FIG. 2 which is a schematic diagram depicting a multi-layer 3D structure of a SoC according to one embodiment of the disclosure.

The schematic diagram shows an integrated circuit 2 with a simplified multi-layer structure. The circuit elements in the multi-layer structure are formed on a semiconductor layer 20 and below a protective layer 26. The present exemplary example shows an eight-layer circuit. The layers from bottom to top include multiple metal layers 221, 222, 223, 224, 225, 226, 227, and 228 that are separated by multiple insulation layers 24. The integrated circuit 2 forms a circuit system that includes the metal layers (221 to 228), in which a part or the entire circuit system will form of various circuit elements. It should be noted that the circuit system of the present disclosure is not limited by the layers described in the above-mentioned embodiments of the multi-layer semiconductor structure.

In the circuit system that applies the method for compensating voltage drop with the additional power mesh of the present disclosure, the circuit elements of the integrated circuit 2 can be mounted on part of the structure, e.g., the metal layers 221 to 226. There are metal wires disposed among the circuit elements. The power mesh can be formed over the metal layers 227 to 228. The circuit elements and the power tracks can be electrically interconnected through vias and wires.

According to one of the objectives of the method for compensating the voltage drop of the disclosure, the layout tracks of the circuit layout can be re-used as part of the power tracks of the power mesh for compensating the voltage drop and also solving the problems of insufficient or unstable operating voltages.

FIG. 3 shows a curve diagram that depicts a trend of the drop in operating voltages of the circuit elements and time. The vertical axis of the diagram denotes the operating voltage, and the horizontal axis denotes the time. A curve 301 shows the voltage drop caused by the resistance of the wires of a specific circuit element during a starting time of the system. The curve 301 also shows that the operating voltage is gradually stabilized within a range of voltage values after a specific period of time.

A curve 303 shows the changes of operating voltages when the method is applied to the circuit system for compensating the voltage drop. As shown in FIG. 3, even though the voltage drop still occurs, the phenomenon of the voltage drop has been improved by the compensation method. The improvement goal can be adjusted according to the needs of the circuit system. The additional power tracks are adjusted so as to compensate for the voltage drop. The diagram shows an improvement by x %, e.g., 10%. The voltage drop can therefore be improved and stabilized over time.

In the method for compensating voltage drop with additional power mesh, a voltage drop analysis is performed. The voltage drop analysis is a computer-implemented simulation method. In a simulation process, power is supplied to a circuit layout. A simulation program is performed for obtaining operating voltages with respect to each region of the circuit layout. A distribution of voltage drops for the circuit layout can be obtained.

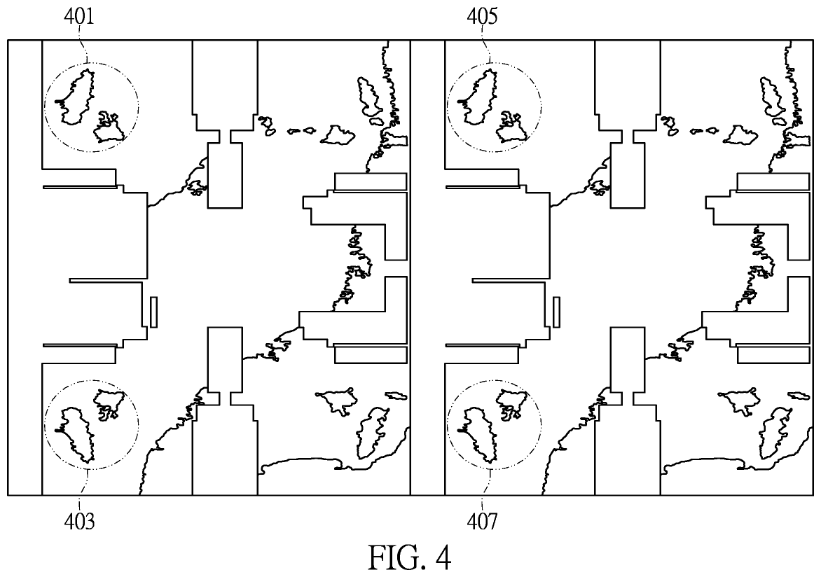

Reference is made to FIG. 4, which is a schematic diagram depicting the voltage drop analysis in the circuit layout according to one embodiment of the disclosure. The diagram shows the status of a voltage drop of a circuit layout in a semiconductor chip through a route track aware opt power mesh ir_drop analysis. An image-processing method is then performed to indicate degrees of voltage drop with respect to different regions by color blocks. The diagram shows a simulation graph indicative of the voltage drops of the regions of the circuit layout after performing the simulation program.

In the method, one or more voltage values are supplied to the circuit layout and the voltage drops of the operating voltages of different circuit elements or at different positions of the circuit layout are calculated separately. The voltages are then calculated by a statistical method. The route track aware opt power mesh ir_drop analysis is used to detect the output voltage of every region so as to obtain the voltage drop. A distribution map of voltage drops is formed. A reference is set in the method. After comparing the voltage drop of every region with the reference, a voltage drop ratio for every region can be obtained. In the present exemplary example, the diagram produced a few regions circled (401, 403, 405, and 407) with larger voltage drops.

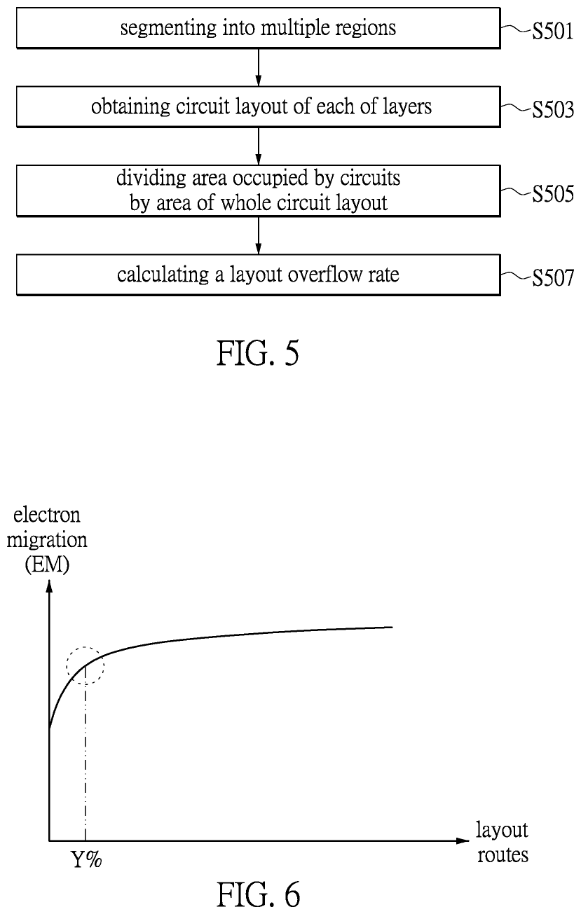

In the method for compensating voltage drop, one of the objectives thereof is to compensate the voltage drop obtained by the above-mentioned method by deploying the additional power mesh in the circuit layout. The positions for deploying the additional power tracks of the power mesh are suggested through the layout overflow analysis. FIG. 5 shows a flow chart describing the process of the layout overflow analysis according to one embodiment of the disclosure.

In the beginning of step S501, the circuit layout of the circuit system is logically segmented into multiple regions according to the demand and requisite precision. The segmented regions are used for determining routing overflow rates. The multi-layer semiconductor structure can be segmented layer-by-layer into multiple regions. The layout overflow analysis is performed on each of the layers.

In step S503, a circuit layout with respect to each layer of the multi-layer semiconductor structure is obtained. The circuit layout shows the layout tracks and the occupied tracks in each of the regions. The occupied tracks are such as the signal tracks of the circuit elements. In an exemplary example, for a simulation program, the signal tracks among the circuit elements are known, the longitudinal and latitudinal power tracks are known, and the unused metal wires are also known. Therefore the layout overflow analysis can be performed based on the given conditions.

Next, in step S505, in each of the regions, the routing overflow rate can be expressed in various ways. For example, the routing overflow rate can be obtained by dividing an area being occupied by the tracks by an area being occupied by the entire layout tracks of the same region, similar to step S507. After the routing overflow rate is obtained, the routing overflow rate defined above can be used to obtain changes in every region, and also provide suggestions of the layout for the power mesh.

In one embodiment of the disclosure, the approach for deploying the additional power tracks can be configured to reach a preset compensation ratio, e.g., 10% of the voltage drop. When re-using the unused metal wires of the circuit system, the positions and quantities of the additional power tracks can be adjusted according to the compensation requirements. It should be noted that the requirement of compensation is such as a compensation ratio of 10% of the voltage drop, the positions of the power tracks are such as the regions to be deployed, and the quantity of the power tracks can be deployed by an area ratio occupied by the power tracks.

The routing overflow rate reflects a wiring density of the occupied circuit system, so that the circuit system can rely on the routing overflow rate to add on different proportions of power tracks of the power mesh. For example, the wiring density of layout tracks is smaller if the routing overflow rate is low, and additional power tracks can be added in the regions with a low routing overflow rate. That means the unused metal wires of the circuit system can be used as the additional power tracks of the power mesh. On the other hand, the higher wiring density of the layout tracks indicates a higher routing overflow rate, fewer power tracks of the power mesh or even no power tracks should be deployed.

After performing the layout overflow analysis, a ranking of the routing overflow rates with respect to the regions can be obtained. The additional power tracks of power mesh are deployed according to the ranking of the routing overflow rates. The result of the layout overflow analysis shows the regions with higher routing overflow rates and the regions with lower routing overflow rates. The regions with higher routing overflow rates have lower probability of available layout tracks that also means less unused metal wires can be re-used. On the contrary, the regions with lower routing overflow rates have more unused metal wires that can be used to deploy the additional power tracks for compensating the voltage drop. This approach achieves the purpose of voltage drop compensation without additional hardware cost.

In one embodiment of the disclosure, the positions and quantities of power tracks of the power mesh can be decided to be deployed according to the routing overflow rate and a ratio of the area occupied by the metal wires of the circuit layout. In one embodiment of the disclosure, when weighing out an amount of power tracks to be deployed on the circuit system, a degree of voltage drop compensation and electron migration should be considered.

After performing the layout overflow analysis, the circuit system can receive one or more suggestions of a layout with the additional power mesh. In addition to reaching the purpose of voltage drop compensation, the method also assists the circuit system to avoid electron migration (EM) effect caused by the metal wires since the electron migration over the wires may cause the program of ion diffusion. Reference is made to FIG. 6, which shows a curve exemplarily depicting the relationship between the layout tracks and the effect of electron migration.

The curve shown in FIG. 6 indicates a relationship between the quantity or an area ratio of the layout tracks and the effect of electron migration. The curve shows the original circuit layout with a certain proportion of electron migration.

The unused metal wires of the circuit layout can be re-used for improving the phenomenon of electron migration. However, the curve shows an increasing quantity of layout tracks, which can improve the electron migration effectively when a ratio of the layout tracks reaches a certain ratio (Y %, e.g., 5%). For example, the improvement of electron migration can reach 60%. Nevertheless, when the layout tracks reach a certain quantity (or area) or more, increasing the layout tracks to solve the phenomenon of the electron migration effect is limited.

When re-using the unused metal wires of the circuit system, to adjust the compensation ratio (X %) of the voltage drop, the positions and quantities of power tracks are determined to be deployed according to a degree of electron migration in the circuit system with a corresponding ratio (Y %) of power tracks to be improved.

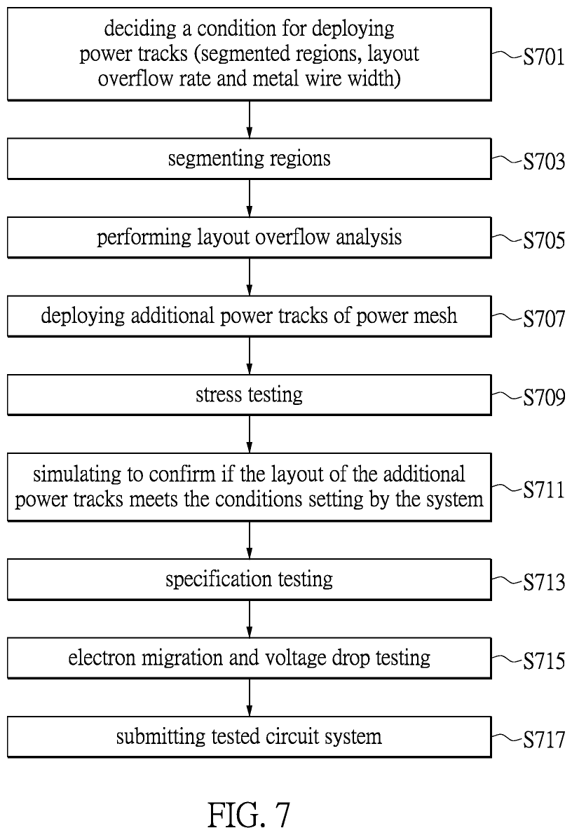

Reference is made to FIG. 7, which shows a flow chart describing the method for compensating voltage drop with additional power mesh according to one embodiment of the disclosure. In the flow chart, according to requirements of precision of the circuit layout, the circuit layout is configured to be segmented into one or more regions. The whole circuit layout can also be one single region.

In step S701, the circuit layout needs to be segmented into one or more regions (or the entire layout as one) to determine conditions to deploy the power tracks. The conditions to deploy the power tracks are such as a routing overflow rate and the width of the metal wires. Next, in step S703, according to actual requirements, the circuit layout is segmented into one or more regions that are used for subsequent analysis.

In an exemplary example, the regions being expressed by grid(n,n) segmented from every circuit layer are firstly defined. There are ‘nxn’ regions ($num(1,1), $num(1,2), . . . , $num(n,n)) in form of an array. After that, a layout overflow analysis is performed region-by-region (step S705) so as to obtain a degree, e.g., quantity and type, of layout overflow with respect to each of the regions. Routing overflow rates with respect to the one or more regions can be obtained. The routing overflow rates are sorted so as to obtain a low-to-high ranking The regions with relatively-low routing overflow rates have priority to be selected for adding the power tracks. The additional power tracks of power mesh are then deployed according to the above conditions (step S707).

However, besides the regions with relatively-low routing overflow rates that can be selected to deploy the additional power tracks, there are still other conditions to be weighed in for the deployment. For example, the condition to be weighed in for deploying the additional power tracks can be the routing overflow rate plus the widths of the metal wires of the circuit layout. The widths of the metal wires represent an area ratio of the tracks of the circuit layout. A specific ratio, e.g., 5%, of an area that is not occupied by the layout tracks can be referred to as a limiting condition for selecting the positions and quantities of additional power tracks to be deployed. Therefore, the limiting condition of the area ratio causes the regions that are larger than the ratio not being able to deploy the additional power tracks even if some regions still have space to deploy the additional power tracks.

Next, in step S709, a stress test is performed on the circuit system that is configured to deploy the additional power tracks. The stress test can be a software simulation procedure. In the software simulation procedure for the stress test, different values of voltages are inputted to the circuit system that is deployed with the additional power tracks of the power mesh. In step S711, the software simulation procedure verifies whether or not the layout of the additional power tracks meets a preset setting according to the simulated procedure and the outputs. After completing and passing the stress test, there will be more follow-up evaluations.

When the layout of the additional power tracks is decided, in addition to the above-mentioned conditions, the specifications of the following procedure should be in consideration. In step S713, a specification test is performed. The specification test is a rule of a manufacturing process such as a design rule check (DRC) regulated by a wafer foundry. DRC requires the circuit layout of the circuit system to meet the specification for actual production. Further, DRC introduces the circuit system, e.g., an IC, a checking tool provided by the wafer foundry for checking the layers of the multi-layer semiconductor structure. The software simulation procedure debugs and verifies the multi-layer semiconductor structure for meeting the specifications.

After passing the above-mentioned inspection, in step S715, the circuit system with the additional power tracks can be processed with an electron migration and voltage drop test. While the additional power tracks are decided to be deployed on the circuit system, a degree of electron migration to be improved in the circuit system can be considered. Since the improvement of electron migration has a limit, it is not beneficial to deploy too many power tracks once the appropriate positions and quantities of power tracks are decided. The voltage drops of the circuit system that has been deployed with the additional power tracks are calculated for determining whether or not the compensation of the voltage drop meets an expected effect.

After finishing the layout design and inspection, such as in step S717, the design can be submitted to the subsequent process for manufacturing the circuit system. It should be noted that the inspection in the above method for compensating voltage drop with additional power mesh is not limited to the above steps and the steps can also be changed back and forth.

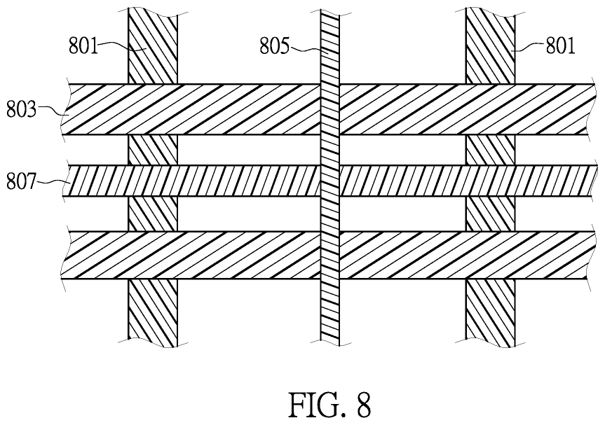

Next, the circuit system that is manufactured by the compensation method with the additional power mesh is referred to FIG. 8, which schematically shows the power tracks of the power mesh of the circuit system. In the shown power mesh, the original power tracks include longitudinal power tracks 801 and latitudinal power tracks 803. The additional power tracks include the newly-added longitudinal power tracks 805 and the newly-added latitudinal power tracks 807.

The circuit system includes a multi-layer semiconductor elements structure that can be an integrated circuit. The circuit elements can be formed on one or more layers of the structure. The circuit layout also includes the signal tracks among the circuit elements. According to actual requirements, the power mesh can be deployed on one or more layers of the structure. The power mesh can be deployed to some specific layers of the structure or the layers with fewer circuit elements based on a design choice. The power mesh can be composed of a plurality of longitudinal and latitudinal power tracks.

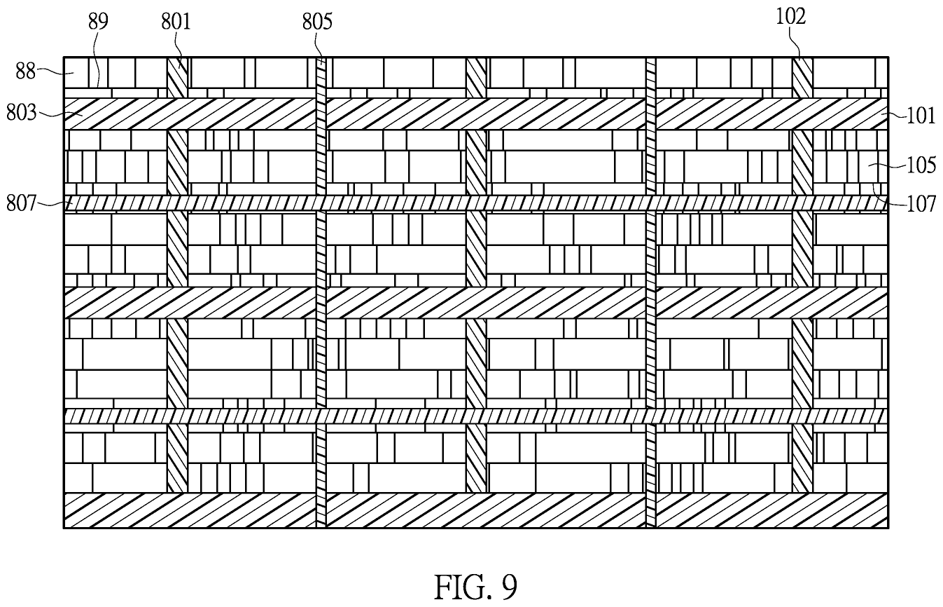

FIG. 9 is a schematic diagram depicting a compensation method for voltage drop using an additional power mesh of a circuit system in an exemplary example.

The power mesh shown in the diagram includes the longitudinal power tracks 801, the latitudinal power tracks 803, the newly-added longitudinal power tracks 805 and newly-added latitudinal power tracks 807. The rest of the circuit system is the circuit elements 88 and the signal tracks 89 among the elements. The power tracks 801, 803, 805, and 807, the circuit elements 88 and the signal tracks 89 can be mounted at one or more specific layers of the circuit system.

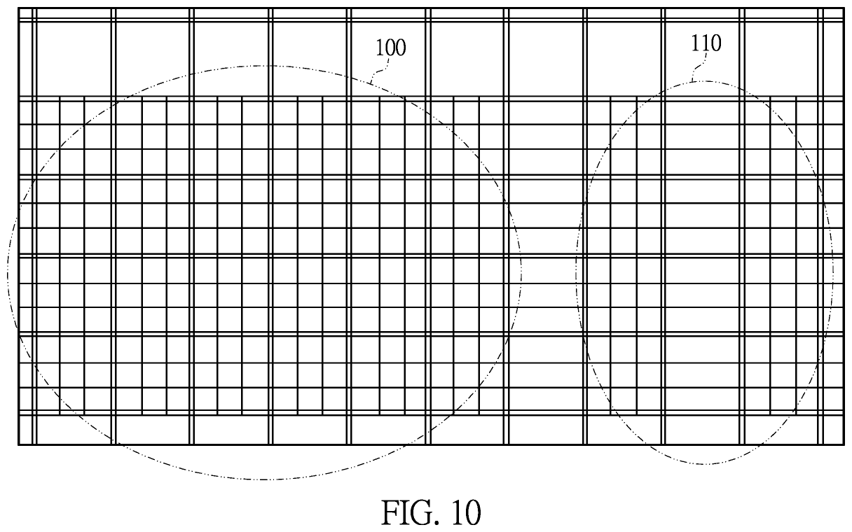

Reference is made to FIG. 10, which is another schematic diagram depicting a power mesh that is formed by the method for compensating voltage drop with additional power mesh in one embodiment of the disclosure. The diagram shows a circuit system with power tracks. As discussed above, the routing overflow rate can be a main factor to deploy the additional power tracks of the power mesh. Further, to deploy the additional power tracks in the regions can be weighed in based on actual requirements. Rather than simply adopting a large quantity of power tracks, the limits of the overall effectiveness of the system should be taken into account. It should be noted that, according to actual requirements, it is not necessary to deploy the additional power tracks over the whole circuit layout evenly, such that the region 100 with a higher density of power tracks and the region 110 with a lower density of power tracks may be formed.

In conclusion, the method for compensating voltage drop with additional power mesh and the circuit system thereof are described in the above embodiments and provided as a solution to compensate for the voltage drop. In one of the methods, a layout overflow analysis is performed to obtain the situation of layout overflow of an integrated circuit, and a routing overflow rate with respect to every region of the circuit layout can be obtained. The routing overflow rates allow the system to obtain the appropriate positions such as the region with low routing overflow rate for deploying the additional power mesh. The additional power tracks are applied to the circuit layout according to the densities of the original power tracks, and the voltage drop can be effectively compensated.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for compensating voltage drop with additional power mesh, adapted to a circuit system, comprising:
segmenting a circuit layout of the circuit system into one or more regions;
performing a layout overflow analysis in each of the regions for obtaining a routing overflow rate with respect to each of the regions; and
deploying additional power tracks of the power mesh according to a ranking of the routing overflow rates with respect to the one or more regions so as to compensate voltage drop of the circuit system.

2. The method according to claim 1, wherein one layer of the circuit system is segmented into one or more regions, the additional power tracks of the power mesh are deployed on unused metal wires of the layer.

3. The method according to claim 1, wherein the layout overflow analysis is performed based on a plurality of layout tracks being segmented in each region of the circuit system, wires used as signal tracks between the circuit elements of the circuit system, and power tracks of the power mesh.

4. The method according to claim 3, wherein the routing overflow rate is obtained by dividing an area occupied by the signal tracks and the power tracks of the power mesh by an area occupied by all of the layout tracks of the same region.

5. The method according to claim 4, wherein the routing overflow rate is also affected by widths of metal wires of the circuit layout of the circuit system.

6. The method according to claim 5, wherein, positions and quantities of the additional power tracks of the power mesh are decided to be deployed according to the routing overflow rate and the area ratio of the width of all metal wires of the circuit layout of the circuit system.

7. The method according to claim 1, wherein, positions and quantities of the additional power tracks of power mesh to be deployed are determined according to a compensation ratio of a voltage drop set by the circuit system.

8. The method according to claim 7, wherein the positions and quantities of the additional power tracks of the power mesh to be deployed are further determined according to a degree of electron migration to be improved in the circuit system.

9. A circuit system that applies a method for compensating voltage drop with additional power mesh, comprising:
a multi-layer semiconductor structure, wherein multiple circuit elements and signal tracks there-between are formed on one or more layers of the structure, and a power mesh is deployed over the one or more layers of the structure, and wherein the power mesh includes a plurality of longitudinal and latitudinal power tracks;
wherein additional power tracks of the power mesh are deployed for compensating the voltage drop of the circuit system, and the method for compensating voltage drop with additional power mesh includes:
segmenting a circuit layout of the circuit system into one or more regions;
performing a layout overflow analysis in each of the regions for obtaining a routing overflow rate with respect to each of the regions; and
deploying additional power tracks of the power mesh according to a ranking of the routing overflow rates with respect to the one or more of the regions so as to compensate voltage drop of the circuit system.

10. The circuit system according to claim 9, wherein the additional power tracks of the power mesh are deployed on unused metal wires of the layer.

11. The circuit system according to claim 9, wherein the layout overflow analysis is performed based on a plurality of layout tracks being segmented in each region of the circuit system, wires used as signal tracks between the circuit elements of the circuit system, and power tracks of the power mesh.

12. The circuit system according to claim 11, wherein the routing overflow rate is obtained by dividing an area occupied by the signal tracks and the power tracks of the power mesh by an area occupied by all of the layout tracks of the same region.

13. The circuit system according to claim 12, wherein the routing overflow rate is also affected by widths of metal wires of the circuit layout of the circuit system.

14. The circuit system according to claim 13, wherein, positions and quantities of the additional power tracks of the power mesh are decided according to the routing overflow rate and the area ratio of the width of all metal wires of the circuit layout of the circuit system.

15. The circuit system according to claim 9, wherein, positions and quantities of the additional power tracks of the power mesh are decided to be deployed according to a compensation ratio of a voltage drop set by the circuit system.

16. The circuit system according to claim 15, wherein the positions and quantities of the additional power tracks of the power mesh are decided to be deployed further according to a degree of electron migration to be improved in the circuit system.
